(19) United States
(12) Patent Application Publication
(10) Pub. No.: US 2013/0126725 A1
(43) Pub. Date: May 23, 2013

(54) Analyses of Analytes by Mass Spectrometry with Values in at Least 3 Dimensions

(71) Applicants: Jurgen Hartler, Graz (AT); Gerhard Thallinger, Graz (AT)

(72) Inventors: Jurgen Hartler, Graz (AT); Gerhard Thallinger, Graz (AT)

(73) Assignee: TECHNISCHE UNIVERSITÄT GRAZ, Graz (AT)

(21) Appl. No.: 13/813,110

(22) PCT Filed: Jul. 26, 2011
(86) PCT No.: PCT/EP2011/062818

§ 371 Date: Jan. 29, 2013

(30) Foreign Application Priority Data
Jul. 30, 2010 (EP) 10171450.9

(51) Int. Cl. H01J 49/00

(52) U.S. Cl. CPC H01J 49/0036
USPC 250/282

(57) ABSTRACT

A method for analysis of analytes in a sample and to the use of such a method and a method for monitoring progress, or treatment of a disease such as fat-related disease. These analysis methods include the steps of providing the sample, measuring of values of analytes in the sample, calculating of values based on the measured values, identifying and optionally visualizing analytes can particularly be used for monitoring quantitative changes of analytes and for monitoring progress or treatment of a disease such as a fat-related disease.

The present invention relates to a method for analysis of analytes in a sample according to independent claim 1 and more particularly to a use of such a method and a method for monitoring progress or treatment of a disease such as fat-related disease. Such analysis methods comprising the steps of providing a sample, measuring values of analytes in the sample using a profiling platform and identifying the measured analytes can particularly be used for monitoring quantitative changes of analytes and for monitoring progress or treatment of a disease.

Advances of lipidomics technologies utilizing mass spectrometry have led to a rapid increase in the number, size and rate at which datasets are generated. Monitoring quantitative changes of many analytes in such datasets requires the usage of automated and reliable software tools.

An algorithm for automated statistical analysis of protein abundance ratios (ASAPRatio) of proteins contained in two samples has been previously described (Li et al, Anal. Chem 2003; 75: 6648-6657). In that study, proteins are labelled with distinct stable-isotope tags and fragmented, and the tagged peptide fragments are separated by liquid chromatography (LC) and analyzed by electrospray ionization (ESI) tandem mass spectrometry (MS/MS). The algorithm used within this study utilizes the signals recorded for the different isotopic forms of peptides of identical sequence and numerical and statistical methods to evaluate protein abundance ratios and their associated errors. The algorithm also provides a statistical assessment to distinguish proteins of significant abundance changes from a population of proteins of unchanged abundance. To evaluate its performance, two sets of LC-ESI-MS/MS data were analyzed by the ASAPRatio algorithm without human intervention, and the data were related to the expected and manually validated values.

Hartler et al. reports on a platform for management and analysis of proteomics LC-MS/MS data which is based on the Proteome Experimental Data Repository (PEDro) relational database schema and follows the guidelines of the Proteomics Standards Initiative (PSI) (Hartler et al, BMC Bioinformatics 2007; 8:197). The described system provides customizable data retrieval and visualization tools, as well as export to PRoteomics IDEntifications public repository (PRIDE).

Katajamaa et al describes methods for automated processing of large numbers of spectra, enhanced secondary peak picking method, as well as extension of software to post-processing by implementation of two methods of non-linear mapping of high-dimensional profile data into two-dimensional space (Katajamaa et al., Bioinformatics 2006, 5: 634).

Further, Haimi et al reports on methods for correcting for the overlap of isotopic patterns typical for lipidome data including integration of databases, isotopic pattern calculation, peak deconvolution, and quantitation in software visualizing MS chromatograms as two-dimensional maps (Haimi et al., Anal. Chem. 2006, 78: 8324).

All of the methods described above are not readily applicable to confine closely overlapping values (e.g. peaks) of analytes in samples, like lipid species. Automated and reliable analysis methods for identification and quantitation of such analytes are lacking down to the present day. There is therefore an unmet need for an improved analysis method enabling a high discriminatory power between analytes having closely overlapping values (e.g. peaks) as well as a reduction of the effect of overlaps.

The present invention addresses this need by providing an analysis method enabling identification of analytes having closely overlapping values by confining the calculated value of each analyte in three or more dimensions.

According to the invention this need is settled by a method for analysis of analytes as defined by the features of independent claim 1, by a use as defined by the features of independent claim 11 and by a method as defined by the features of independent claim 13. Preferred embodiments are subject of the dependent claims.

The method according to the first aspect of the present invention comprises the steps of providing a sample, measuring a first set of values of analytes in the sample, and calculating a second set of values based on the measured first set of values. The method further comprises the step of identifying analytes by confining the measured first set of values of each analyte based on the second set of values in three or more dimensions and optionally, visualizing of each confined value of each identified analyte. Preferably, the measuring of the first set of values of analytes can be carried out by using a profiling platform. Preferably, the sample is provided from a subject which can be a plant, animal or human. Preferably, confining the calculated value of each analyte may be in three dimensions or four dimensions or five dimensions. With such a method the analytes are identified and discriminated from analytes, which can be usually not clearly separated by analysis means known in the art, and an objective measure is obtained.

Preferably, the measuring of values of analytes is carried out on the sample, preferably using a profiling platform, such as analytical devices like liquid chromatography mass spectrometry (LC/MS), which enables a reliable and efficient measuring of said analytes.

In one embodiment, the method according to the present invention comprises the calculating of the second set of values based on the measured first set of values comprising the extraction of group of values, such as a chromatogram and mass-to-charge profile, and the quantitation of each value thereof.

In one embodiment, the method according to the present invention comprises within the step of identifying analytes calculation of theoretical isotopic distribution of each analyte of interest from a chemical formula of each analyte, which enables selection of the correct value, such as a peak or group of peaks and which are used as quantitative measures for each analyte.

In one embodiment, the method according to the present invention further comprises calculation of mass-to-charge-profile and chromatogram within the step of identifying analytes.

In one embodiment, the method according to the present invention comprises the determination of four or more border values within the step of identifying analytes. These border values can be used for delimiting the mass-to-charge-time region of the values, which enables the confinement between closely overlapping values (e.g. peaks) and largely reduces the effect of overlaps of said values.

In one embodiment, the three or more dimensions, preferably three dimensions or four dimensions or five dimensions confining the calculated value of each analyte according to the method of the present invention are selected from the group consisting of mass-to-charge-ratio, time and intensity.

In one embodiment, the method according to the present invention further comprises filtering of values which do not fit to the theoretical isotopic distribution within the step of identifying analytes.

In one embodiment, the analytes according to the method of the present invention are selected from a group of single-charged analytes consisting of nucleotides, amino acids, organic acids, sugars, free fatty acids, lipids, derivatives thereof or from a group consisting of multiple-charged analytes consisting of peptides, proteins.

In one embodiment, the sample according to the method of the present invention comprises a body fluid or tissue.

In one embodiment, the body fluid according to the method of the present invention is blood, plasma, serum, sweat, saliva, spinal fluid, faeces, liquor, interstitial liquid, peritoneal liquid, lymph fluid, gall fluid, fluid from a glandular secretion, sputum, urine. Like this, the method of the present invention can be used in clinical application, or for research purposes.

In one embodiment, the tissue according to the method of the present invention is selected from a group consisting of tissue located beneath the skin (e.g. subcutaneous fat), tissue around internal organs (e.g. visceral fat), tissue in bone marrow (e.g. yellow bone marrow) and tissue in breast.

Another aspect of the invention relates to the use of the method according to the present invention for risk prediction of future life threatening events in disease. For example, in case of a fat-related disease, such a prediction can be based on the analysis of analytes such as lipids using the method according to the present invention. Thus, a profile of the analysed analytes such as lipids can be prepared for a subject as defined herein above and the risk to suffer in the future under a certain disease such as fat-related disease can be predicted by comparing the analyte profile such as lipid profile of the subject to be analysed with standard analyte profiles such as lipid profiles of subjects suffering or non-suffering under the certain disease such as fat-related disease.

In one embodiment, the disease according to the use of the method of the present invention is fat-related disease.

Still another aspect of the invention relates to a method for monitoring progress or treatment of a disease, comprising the steps of (a) measuring values for analytes by using the method according to the first aspect of the invention, wherein the measured values are predetermined to be indicative of the disease; (b) repeating step (a) after a period of time during which subjects receive treatment for the disease, to obtain values representing post-treatment; (c) comparing values representing post-treatment from step (b) with the measured values in step (a) versus values representing subjects not suffering under the disease, and (d) classifying said treatment as being effective if the values from step (b) are closer to the values representing subjects not suffering under the disease than to the measured values from step (a).

Advantageously, the method for monitoring progress or treatment of a disease can be used in clinical diagnostics, prognosis and risk prediction of disease, for example fat-related disease. By applying the method of the present invention in a clinical field, it is possible, for example, to determine the lipid profile of subjects by identifying the molecular species originating from different lipid classes. This lipid profile may be helpful in the adaption of a diet of a subject in order to prevent or treat a subject suffering under such a disease.

In one embodiment, the period of time according to the method for monitoring progress or treatment of a disease of the present invention is within a range of minutes, hours, days, months or years.

In one embodiment, the disease according to the method for monitoring progress or treatment of a disease of the present invention is fat-related disease.

In one embodiment, the period of time according to the method for monitoring progress or treatment of a disease is within a range of minutes, preferably 1, 2, 3, 4, 5, 6, 7, 8, 9, 10, 20, 30, 40, 50, 60, 120 or 240 minute(s), hours, preferably 1, 2, 3 or 4 hour(s), days, preferably 1, 2, 3, 4, 5, 6, 7, 8, 9, 10, 10 to 20, 20 to 28, 20 to 29, 20 to 30, 20 to 31, 20, 28, 29, 30, 31 day(s) or months, preferably 1, 2, 3, 4, 5, 6, 7, 8, 9, 10, 11 or 12 month(s) after the onset of said disease or treatment.

The disease, disorder or defect according to the methods of the invention and their uses can be selected from fat-related diseases. Particularly, this kind of defect, disorder or disease is correlated or indicated with arthritis, rheumatoid arthritis, gallstones, skin disease such as acne, blackheads, and white heads, diabetes, multiple sclerosis, asthma.

Still another aspect of the invention relates to a computing system such as, e.g., a processor-based desktop computer or a processor based computing apparatus integrated into another device (embedded system). The system comprises computing means (such as a processor) and a memory which are arranged to perform at least part of the steps of the methods according to the invention. In particular, the computing system comprises means for automatically identifying analytes by confining the calculated value of each analyte in three or more dimensions, preferably three dimensions or four dimensions or five dimensions, and optionally visualization of each confined value of each identified analyte. With such a computing system, the provision of an objective mean for detection and differentiation of analytes, which usually can not be clearly separated by analysis mean known in the art, can be efficiently performed.

Preferably, the computing means and the memory of the computing system are arranged to perform steps of the methods according to the invention as described above. Also, the computing system can comprise an interface for interacting with other devices, such as for example a device for measuring values of analytes in the sample, a device for calculating of measured values of analytes or input/output devices. Still another aspect of the invention relates to a computer program which is arranged to perform at least part of the steps of the methods according to the invention when it is run on a computing system as mentioned above.

### DEFINITIONS

The technical terms and expressions used within the scope of this application are generally to be given the meaning commonly applied to them in the pertinent art of bioinformatics.

As used herein, “analyte” refers to an analyte of interest. Non-limiting examples of analytes include, but are not limited to, single-charged and/or multiple-charged analytes such as amino acid, protein, a polypeptide comprising one or more amino acids in linear or branched configuration, a polypeptide fragment, a peptide analogue partial or complete, a protein in any isoform or fragment, nucleic acid (both DNA or any RNA), a carbohydrate, free fatty acid, lipid, steroid and other bioanalyte. Analyte could also refer to any synthetic analyte such as polymers or other analyte which can be ionized

The term “subject” as used within the present invention relates to a source of an analyte, or a sample comprising the analyte. Such a source can be natural or synthetic. Non-limiting examples of sources for the analyte, or the sample comprising the analyte, include cells or tissues, or cultures (or subcultures) thereof. Non-limiting examples of analyte sources include, but are not limited to, crude or processed cell lysates, body fluids, tissue extracts, cell extracts or fractions (or portions) from a separations process such as a chromatographic separation, electrophoretic separation, a 2D electrophoretic separation or a capillary electrophoretic separation. Body fluids include, but are not limited to blood, plasma, serum, sweat, saliva, spinal fluid, faeces, liquor, interstitial liquid, peritoneal liquid, lymph fluid, gall fluid, fluid from a glandular secretion, sputum, urine. The cell lysates are processed or is treated, in addition to the treatments needed to lyse the cell, to thereby perform additional processing of the collected material. For example, the sample can be a cell lysate comprising one or more bioanalytes that are peptides formed by treatment of the cell lysate with a proteolytic enzyme to thereby digest precursor peptides and/or proteins.

Further, the term “subject” refers to a source of an analyte obtained from any warm-blooded animal, particularly including a member of the class mammalia such as, without limitation, humans and non-human primates such as chimpanzees and other apes and monkey species; farm animals such as cattle, sheep, pigs, goats and horses; domestic mammals such as dogs and cats; laboratory animals including rodents such as mice, rats and guinea pigs, and the like. The term does not denote a particular age or sex and, thus, includes adult and newborn subjects, whether male or female.

As used herein, the term “profiling platform” relates to analytical devices like targeted mass spectrometry (MS) or quantitative mass spectrometry (MS), which is enabled by coupling mass spectrometry (MS) with liquid chromatography (LC). Particularly, the term “profiling platform” relates to liquid chromatography (LC) in combination with electrospray ionization (ESI) mass spectrometry (MS). “Mass spectrometer” refers to an electrospray ion spectrometer that measures a parameter that can be translated into mass-to-charge ratios of ions. Mass spectrometers generally include an ion source and a mass analyzer. Examples of mass spectrometers are time-of-flight, magnetic sector, quadrupole filter, ion trap, ion cyclotron resonance, electrostatic sector analyzer and hybrids of these. “Mass spectrometry” refers to the use of a mass spectrometer to detect gas phase ions.

The term “value” or “values” as used within the present invention relates to numerical scores which can be visualized in form of peaks. As used herein, the “value” can be classified in different kind of set of values depending on the step of the method according to the present invention. For example, a first set of values for analytes in the sample can be obtained upon measuring by using a profiling platform, such as mass spectrometry (MS). A second set of values can be obtained upon calculating based on the measured first set of values for generation of chromatograms and mass-to-charge-profile. A third set of values can be obtained upon identifying analytes by confining the measured first set of values of each analyte based on the second set of values.

As used herein, “peak” is a confined region, comprising of several intensities. Normally the summation of the intensities is then used as a quantitative measure for the analyte. The term “confine”, “confining” or “confinement” as used herein relates to limit or restrict peak or values being graphically represented by the peak and obtained by measurement within a profiling platform as defined herein above based on border values or dimensions such as mass-to-charge-ratio, time and value intensity.

The term “normal subjects” relates to a subject as defined herein above not suffering under a disease to be monitored.

The term “sample” as used herein refers to a “biological sample”, meaning a sample obtained from a subject. The biological sample can be selected, without limitation, from the group consisting of blood, plasma, serum, sweat, saliva, spinal fluid, faeces, liquor, interstitial liquid, peritoneal liquid, lymph fluid, gall fluid, fluid from a glandular secretion, sputum, urine, and the like. As used herein, “serum” refers to the fluid portion of the blood obtained after removal of the fibrin clot and blood cells, distinguished from the plasma in circulating blood. As used herein, “plasma” refers to the fluid, noncellular portion of the blood, distinguished from the serum obtained after coagulation.

The term “discriminatory power”, as used herein, refers to the discriminatory ability of variables or values to separate between two or more analytes of a sample.

The term “diagnosis”, as used herein, is a label given for a medical condition, disease, disorder or defect identified by its signs, symptoms, and from the results of various diagnostic procedures. The term “diagnosis” includes the recognition of a disease, disorder, defect or condition by its outward signs and symptoms as well as the analysis of the underlying biochemical cause(s) of a disease, disorder, defect or condition. The term “diagnostic criteria” designates the combination of signs, symptoms, and test results that allows the doctor to ascertain the diagnosis of the respective disease.

The term “risk prediction of future life threatening events in disease” defines a particular event in a disease, disorder or defect that will occur in the future with a certain likelihood depending on the respective type of disease, disorder or defect such as fat-related disease as defined herein above. For example, in case of a fat-related disease, such a prediction can be based on the analysis of analytes such as lipids using the method according to the present invention. Thus, a profile of the analysed analytes such as lipids can be prepared for a subject as defined herein above and the risk to suffer in the future under a certain disease such as fat-related disease can be predicted by comparing the analyte profile such as lipid profile of the subject to be analysed with standard analyte profiles such as lipid profiles of subjects suffering or non-suffering under the certain disease such as fat-related disease.

The term “isotope” or “isotopes” relates to different types of atoms (nuclides) of the same chemical element, each having a different number of neutrons. In a corresponding manner, isotopes differ in mass number (or number of nucleons) but never in atomic number. The number of protons (=the atomic number) is the same because that is what characterizes a chemical element. For example, carbon-12, carbon-13 and carbon-14 are three isotopes of the element carbon with mass numbers 12, 13 and 14, respectively. The atomic number of carbon is 6, so the neutron numbers in these isotopes of carbon are therefore 12−6=6, 13−6=7, and 14−6=8, respectively.

As used herein, the term “analyte” is a collective term comprising all molecules in a sample having the same chemical composition, including their isotopes.

The term “theoretical isotopic distribution” refers to the relative (percentage) theoretical occurrence of the isotopes of an analyte in nature. The values of the measured isotopes should proportionally match this distribution.

The term “border value” defines a point (defined by mass to charge ratio (m/z) and retention time (time)) that is located at the detection thresholds of an analyte in the m/z-time map. The term “retention time” defines an elution time from a separation process.

Further or other dimensions than mass to charge ratio or retention time may be used as well to define one or more border value(s).

As used herein, “intensity” refers to quantitative measure for the amount molecules entering the mass detector (at a specific m/z, and time).

The term “TG” is the standardized (by LipidMaps; Fahy et al., J Lipid Res. 2009; 50 Suppl:S9-14) abbreviation for triacylglyceride. As used herein, the term “TG” is used with a notation “X:Y”, such as “56:1”, where “X” is the amount of C atoms in the fatty acyl chains, and “Y” is the amount of double bonds in these chains.

The present invention is further described by reference to the following non-limiting figures, tables and examples. The figures show:

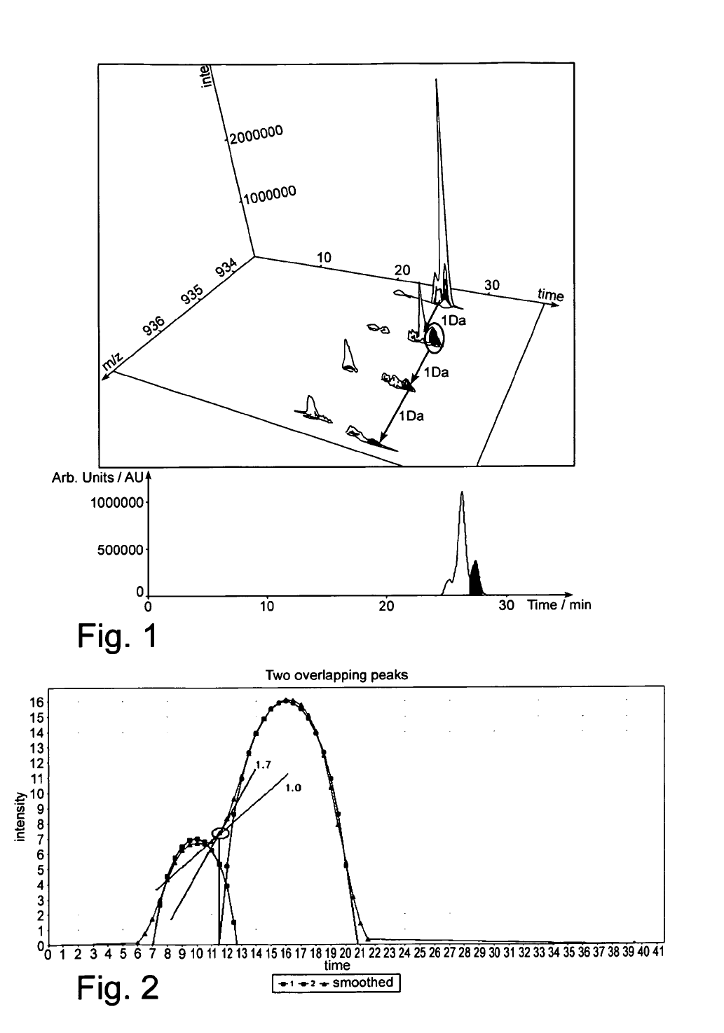

FIG. 1 illustrates the quantitation of TG 56:1. The +2 isotopic peak of TG 56:2 is close to the +0 peak of 56:1. The upper window displays the m/z-time region in 3D. The window at the bottom shows the 2D-chromatogram of the topmost dark peak which is encircled. The presented algorithm selects the correct peak (TG 56:1 darker one) and its isotopic partners automatically by taking the theoretical isotopic distribution into account. The bigger peak in the 2D-chromatogram is excluded from the analysis as it represents the +2 isotopic peak of TG 56:2.

FIG. 2 shows the chromatogram of 2 overlapping peaks. The smoothed chromatogram is depicted by the brighter line with the triangle points. The “greedy steepness method” (see also Example 4, details to step 3a) would detect an abrupt decrease in the gradient of the peak curve in the triangle point encircled and put the lower peak border there.

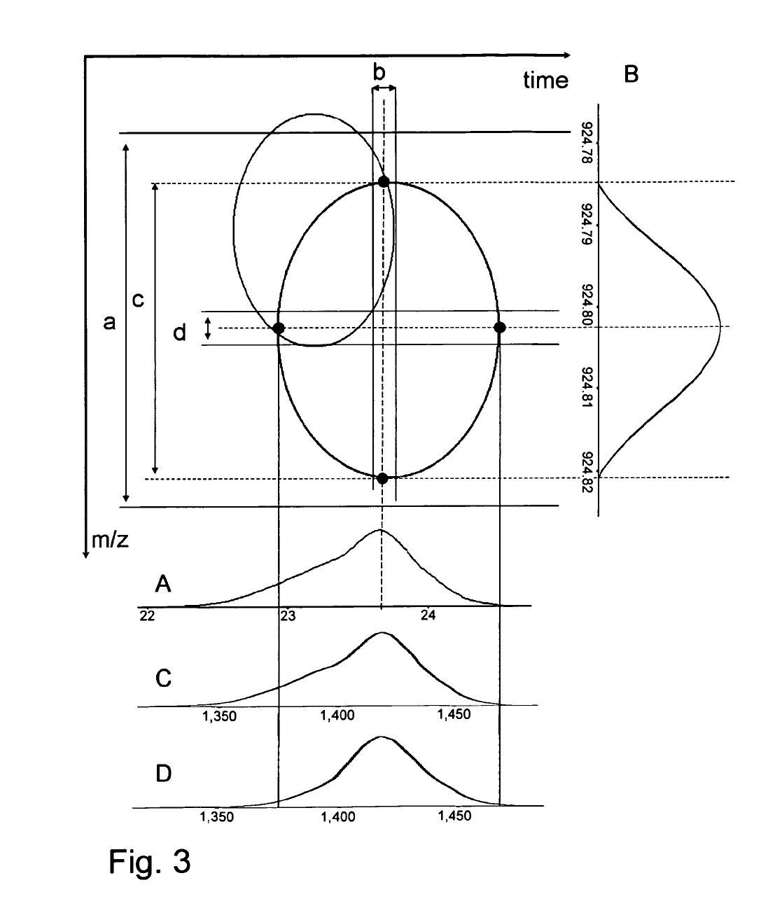

FIG. 3 illustrates the novel algorithm from a top-view on the m/z map. The bigger ellipse represents the peak to be quantified; the smaller one is the overlapping one. First, a standard chromatogram “A” with a broad m/z range “a” is extracted (no overlap distinguishable). Second, at the time point with the highest intensity an m/z-profile “B” with a narrow range “b” is extracted. Third, the m/z borders and the m/z value with the highest intensity are used to extract chromatogram “C” with range “c” (uses borders found in “B”) and “D” with narrow range “d”. “C” and “D” are used to identify borders in the time range. Now 4 border points of the peak are determined (dots on the borders of the bigger ellipse). These are used to calculate an ellipse, which is used as peak confinement. Intensities inside the ellipse only contribute to the total peak intensity.

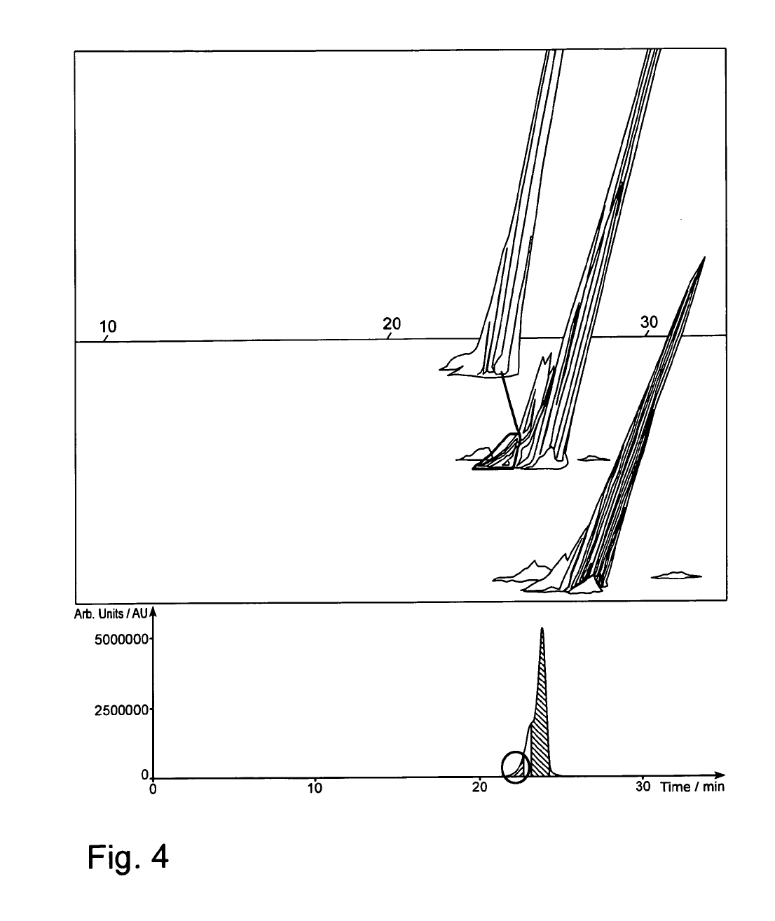

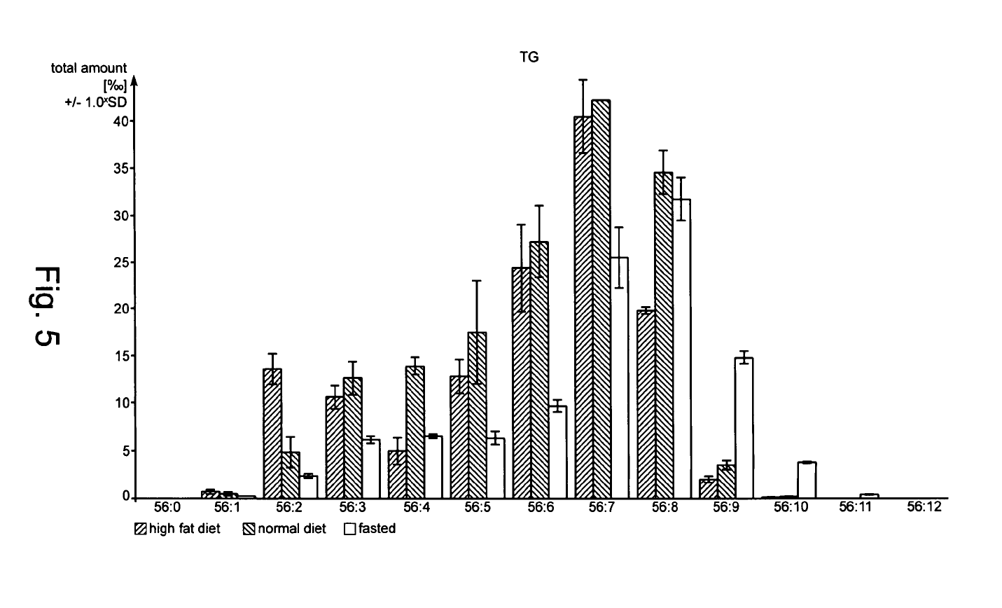

FIG. 4 shows that a small encircled (encircled in 2D view and trapezoid in 3D view) peak has been segregated from the main part of peak. The white part that has been removed because it was identified to be an isotope of a different analyte. Removal based on the preceding isotope just removes the part between the encircled and the large peak, while the small encircled one remains. Therefore an additional check is preformed whether a peak has been removed between the main peak and the additional peak (small encircled one). In that case, the encircled one is removed too.

FIG. 5 illustrates the analysis of lipid samples. In this experiment lipid droplets were extracted from hepatocytes from mice on different diets (fed/high fat diet; fed/normal diet; fasted/normal diet). The values in FIG. 5 represent the amount of analyte relative to the totally measured TG content in per mille. The depicted bar chart (TG56:×analytes are shown) indicates that the TGs of mice under high fat are relatively more saturated (less double bonds) than the others, while mice under fasted conditions show highly unsaturated TGs, which are not even detectable for the other conditions.

The foregoing description will be more fully understood with reference to the following Examples. Such Examples, are, however, exemplary of methods of practicing the present invention and are not intended to limit the scope of the invention.

The following Examples illustrate the invention:

### EXAMPLE 1

### Quantitation of TG 56:1

The algorithm extracts a chromatogram of a certain m/z width and quantifies the peak. In lipidomics, the analytes of interest differ just by one double bond resulting in a mass difference of 2 Dalton (Da). Thus, the main peak (+0) of the analyte of interest has nearly the same mass as the second isotopic peak (+2) of the analyte with one more double bond. The elution times are usually very close due to the physicochemical similarity of the analytes (FIG. 1).

In order to select the correct peak, the algorithm calculates a theoretical isotopic distribution of the analyte of interest and compares it to the peaks that should belong to this isotopic series (+0, +1 and +2). Additionally the algorithm ensures that the +0 peak does not originate from a different isotopic series (the wrong peak in FIG. 1 has a big peak in the distance of −1 Da, which corresponds to a loss of one neutron).

### EXAMPLE 2

### Overlapping Peaks

If no overlapping peaks are detected and a peak was found in the chromatogram at m/z of analyte—mass(neutron)/charge (is around −1 Da for singly charged analytes), the algorithm declares the correct peak to be a result of another isotopic distribution and discards it. Hence, an additional 2D peak border detection method has been implemented that detects overlaps. The algorithm detects the peak borders based on a change in the gradient of the curve (see FIG. 2; detailed description see Example 4, section 3a—greedy steepness method).

However, this border detection method is not sufficiently sensitive, thus an algorithm has been developed that confines the peak in m/z and time direction. The algorithm is based on the extraction of several chromatograms and profiles to detect four peak border points, which are used for the calculation of an ellipse delimiting the m/z-time region used for the peak (see FIG. 3, for details: see Example 4, section 3a).

Taken together, the algorithm as described herein takes the theoretical isotopic distribution into account, provides a new peak border detection method, considers steepness decrease of the gradient, and confines the border values of the peak exactly in time and m/z direction.

### EXAMPLE 3

### Theoretical Isotopic Distribution

In addition to the exact mass of an analyte, the algorithm requires its elemental composition in order to calculate the isotopic distribution based on the natural occurrences of the elements (e.g. p(¹H)=0.99985; p(²H)=0.00015; p(¹⁶O)=0.9976; p(¹⁷O)=0.0004; p(¹⁸O)=0.002; etc.). The probability for the occurrence of an isotopic peak (+×) is the sum of the mutual combinations of atomic isotopes, which result in the +x mass shift: p(+y)=Σp(mutual combinations)

Example for H₂O (³H is neglected because of the extremely low probability):

$$p ( + 0 ) = {p ( {}^{1} H )}^{2 *} p ( {}^{16} O ) = {0.99985}^{2 *} 0.9976 = 0.9973$$

$$\begin{matrix}p ( + 1 ) = {p ( {}^{2} H )}^{*} {p ( {}^{1} H )}^{*} p ( {}^{16} O ) + {p ( {}^{1} H )}^{*} {p ( {}^{2} H )}^{*} p ( {}^{16} O ) + \\ {p ( {}^{1} H )}^{*} {p ( {}^{1} H )}^{*} p ( {}^{17} O ) \\ = {2}^{*} {p ( {}^{2} H )}^{*} {p ( {}^{1} H )}^{*} p ( {}^{16} O ) + {p ( {}^{1} H )}^{*} {p ( {}^{1} H )}^{*} p ( {}^{17} O ) \\ = {2}^{*} {0.00015}^{*} {0.99985}^{*} 0.9976 + {0.99985}^{2 *} 0.0004 \\ = 0.000699\end{matrix}$$

$$\begin{matrix}p ( + 2 ) = {p ( {}^{2} H )}^{2 *} p ( {}^{16} O ) + {p ( {}^{2} H )}^{*} {p ( {}^{1} H )}^{*} p ( {}^{17} O ) + p {( {}^{1} H )}^{*} {p ( {}^{2} H )}^{*} p ( {}^{17} O ) + \\ {p ( {}^{1} H )}^{2 *} p ( {}^{18} O ) \\ = {p ( {}^{2} H )}^{2 *} p ( {}^{16} O ) + {2}^{*} {p ( {}^{2} H )}^{*} {p ( {}^{1} H )}^{*} p ( {}^{17} O ) + {p ( {}^{1} H )}^{2 *} p ( {}^{18} O ) \\ = {0.00015}^{2 *} 0.9976 + {2}^{*} {0.00015}^{*} {0.99985}^{*} 0.9976 + {0.99985}^{2 *} 0.002 \\ = 0.001999\end{matrix}$$

Then, the probabilities are normalized on the p(+0) to calculate a multiplicative factor for the volumes.

$$\begin{matrix}Volume ( + 0 ) = {( p ( + 0 ) / p ( + 0 ) )}^{*} Volume ( + 0 ) \\ = {( 0.9973 / 0.9973 )}^{*} Volume ( + 0 ) \\ = {1}^{*} Volume ( + 0 )\end{matrix}$$

$$\begin{matrix}Volume ( + 1 ) = {( p ( + 1 ) / p ( + 0 ) )}^{*} Volume ( + 0 ) \\ = {( 0.000699 / 0.9973 )}^{*} Volume ( + 0 ) \\ = {0.00701}^{*} Volume ( + 0 )\end{matrix}$$

$$\begin{matrix}Volume ( + 2 ) = {( p ( + 2 ) / p ( + 0 ) )}^{*} Volume ( + 0 ) \\ = {( 0.001999 / 0.9973 )}^{*} Volume ( + 0 ) \\ = {0.02004}^{*} Volume ( + 0 )\end{matrix}$$

The calculated volume is used in the new algorithm to validate the identified peaks. If the peak intensity deviates from the theoretical intensity more than a certain threshold, the peak is regarded as a false identification and is discarded.

### EXAMPLE 4

### Data Processing

A peak volume for an analyte is determined by the following steps:
1) Chromatogram extraction (at m/z of analyte) and smoothing as in the original ASAPRatio algorithm.
2) Chromatogram extraction (at m/z of analyte—mass(neutron)/charge) and smoothing like in the original ASAPRatio algorithm.
3) Iteration over all time points of the chromatogram calculated in 1) and
   a. Calculation of a 3D volume. The volume is valid if it is sufficiently distinguishable from surrounding noise, and the peak summit is sufficiently close to the expected m/z value.
   b. If 3D volume is valid: calculation of volume at the same time-point in the chromatogram calculated in 2);
   c. If volume in a) and b) OK: check if the volume in b) could be a previous isotopic peak of a);
   d. If a) is not an isotopic peak of b) or b) is not there at all, a) is returned as candidate peak; else if a) is an isotopic peak of b), a) is kept as an “previous-isotope-volume” for the calculation of the additional isotopic volumes and the removal of additional isotopic peaks.

At the end of this step redundant peaks (identified more than once) are removed.
4) Discard of very small peaks.
5) Removal of additional isotopic peaks.
6) Merging of neighbouring peaks using stringent thresholds.
7) Chromatogram extraction and peak calculation for additional isotopes.
8) Discard of small peaks.
9) Calculation of additional isotopic peaks that need not necessarily conform the expected intensity from the theoretical isotopic distribution.
10) Merging of neighbouring peaks using relaxed thresholds.
   The steps presented herein above are explained in detail in the following:

### Steps 1) and 2) Chromatogram Extraction

The chromatographic extraction is performed in the same manner as in the ASAPRatio algorithm (Li et al, Anal. Chem 2003; 75: 6648-6657). First, intensities in a certain m/z range (FT=±0.02 Da, Q-TOF-profile=±0.14 Da, Q-TOF-centroid=±0.06 Da, Q-TRAP=±0.35 Da) around the m/z value of the analyte are extracted, leading to a raw chromatogram. This chromatogram is smoothed with Savitzky-Golay filter (smooth range for FT=0.5 s, Q-TOF=12 s, and Q-TRAP=10 s; smooth repeats for FT=10, Q-TOF=5, and Q-TRAP=2). The m/z of the chromatogram of 2) depends on the expected charge of the analyte of interest. If e.g. singly charged analytes are analyzed the m/z of chromatogram 2) is m/z of analyte—mass(neutron), for doubly charged molecules it is m/z of analyte—mass(neutron)/2, for triply charged molecules m/z of analyte—mass(neutron)/3, etc. The extraction of this one chromatogram is in most of the cases sufficient, since the potentially perturbing peak originates in most of the cases from an analyte with an additional double bond (see Example 1). If the exclusion of all potential isotopic peaks is wanted, a chromatogram for every possible charge state has to be extracted. However, in the current implementation, just the chromatogram at m/z of analyte—mass(neutron)/charge is extracted due to performance reasons.

Step 3 a) Calculation of 3D Volume

In FIG. 3 two closely overlapping peaks are depicted. FIG. 3A shows a chromatogram where the decrease in the steepness of the peak is not sufficient to detect a peak border in the standard 2D manner (the peak border detection works always in the same manner->see greedy steepness method below; in every extracted chromatogram/profile the calculated area under the curve must be bigger than the area error and the highest peak intensity must be twice the background; the calculation of the area error and background is described in ASAPRatio paper). Thus a multi-step procedure is applied to detect the overlap and confine the peak border correctly. The procedure acquires two peak border points in time direction and two peak border points in m/z direction. Through these border points an ellipse is fitted, representing the borders of the peak. The four border points are extracted using the following procedure:
The peak borders are confined in the chromatogram extracted in 1), and the highest peak intensity is detected (see FIG. 3A).
At the time point of the highest intensity, an m/z profile is extracted (see FIG. 3B) (time-range: 2 s; smooth range for FT=0.02 Da, Q-TOF-profile=0.1 Da, Q-TOF-centroid and Q-TRAP=0.05 Da; smooth repeats for FT and Q-TOF-centroid=5, Q-TOF-profile=7, Q-TRAP=3).
In the m/z profile again the peak borders and the m/z value of the highest intensity is confined (see FIG. 3B). This m/z value of the summit is not allowed to differ too much from the original one (FT: ±5 mDa; Q-TOF in profile mode: ±100 mDa; Q-TOF centroid data: ±45 mDa; Q-TRAP: ±150 mDa), otherwise step 3a is stopped at this point and the peak is discarded.
The peak borders calculated in the m/z profile represent an m/z range that is used to extract again a chromatogram (see FIG. 3C) (the smooth range and smooth repeats are the same as in step 1 and 2). The only difference for this chromatogram is that just a range of ±5 minutes around the peak is smoothed to accelerate the algorithm, except for Q-TRAP where it is ±7 minutes. For this chromatogram again the peak borders are confined.
In the m/z-region around the highest peak, a chromatogram with a very narrow range (FT: ±2 mDa; Q-TOF: ±10 mDa; Q-TRAP: ±90 mDa; the smooth range is the same as step 1 and 2, but the smooth repeats are higher, since there are quite often not so many data points present—FT=15; Q-TOF=10; Q-TRAP=3) is extracted and again the peak borders are confined. As in the previous step, just the same time region around the peak is smoothed to accelerate the algorithm.
After this procedure, two border points in m/z direction are defined, but several border points in the time direction (chromatogram A, C and D). In general, the border points of the chromatogram with the smaller m/z-range are used (chromatogram D). However, the opposite problem can happen: the overlap is detected by the “greedy steepness method” in the chromatogram A, but because D cuts just parts of the wrong peak, the decrease in the steepness is not so prominent, and the peak borders of D cover the wrong peak. The criteria for this case are:
   In the steepness method the peak border of A is detected by a sudden decrease in the steepness of the gradient and the distance from the peak centre to the border of the chromatogram D is 1.1 times higher than the one of A.
   The distance from the peak centre to the border of the chromatogram D is 1.5 times higher than the one of A, without considering a steepness decrease.

In these cases, the borders of C are used.
If an overlap can be assumed, this finding is stored and is used in 3 c).
   Details to Step 3a)—Greedy Steepness Method

First, the highest peak intensity is detected in the neighbourhood (same algorithm as in ASAPRatio: see Li et al, Anal. Chem 2003; 75: 6648-6657). Second, the algorithm moves to the right side and the left side of the highest intensity and calculates the gradient between the data points (in the original ASAPRatio the border points are set if the intensity increases again). If the intensity increases or the steepness of the gradient decreases from one data point to the next or the intensity falls below 3% of the peak summit (just true for chromatogram D and the m/z profile B, 5% for the chromatogram C) a peak border is assumed. For profile peaks an additional criterion is applied: a border point is assumed if the distance from the summit to the border exceeds a certain threshold (FT=0.02 Da, Q-TOF-profile: 0.2 Da, Q-TOF-centroid: 0.08 Da, Q-TRAP: 0.6 Da). In order to measure the steepness decrease, the quotient (quot) between the gradient of the current data point to the next data point is calculated:

quot=grad_{curr}/gradₙₑₓₜ

If this quotient exceeds a certain value the border point value is set (see FIG. 2). The algorithm allows two definable thresholds for the quotient, depending on the intensity in relation to the highest intensity. The reason for 2 thresholds is that in regions of lower signal intensity (int<0.2*max) (int: intensitiy of the current data point; max: intensity of peak summit) the steepness of the gradient varies more. If int>0.2*max the quot must be >1.5 (for the chromatogram C 1.33 is sufficient) to assume a border point, if 0.15*max<int<=0.20*max the quot must be >1.8 to assume a border point. For int<=0.15*max the intensity of the next point must be higher than the previous one (standard ASAPRatio method as described in Li et al, Anal. Chem 2003; 75: 6648-6657). In the example of FIG. 2, the quotient is 1.7/1.0 =1.7, which is higher than 1.5 and the algorithm will put a peak border point there.

Step 3 b) Calculation of peaks in the −1*Mass(Neutron)/Charge Chromatogram

If the detected peak (calculated in 3a) is an isotope of another analyte with a different +0 mass than the analyte of interest, there must be a peak at the same retention time in the chromatogram at the m/z value of the analyte of interest minus the mass of one neutron/charge (see Example 1). To this end, the volumes in the −1*mass(neutron)/charge chromatogram are calculated.

If a 3D volume is detectable (criteria are described in Example 4, step 3a), the algorithm tries to calculate peaks in the time neighbourhood of the identified peak in the −1*mass(neutron)/charge chromatogram. These peaks are calculated using standard 2D-method as described in ASAPRatio (Li et al, Anal. Chem 2003; 75: 6648-6657) due to computational constraints. For this calculation all scans are used that are ±5 scans around the time borders of the 3D peak calculated in step 3a. If the “greedy steepness” method identifies an overlap, the 5 scans at the side of the overlap are not included, but just the border values are used.

Step 3 c) Check if Peak is From Another Isotope

If volumes are detectable in 3b, the following criteria have to be fulfilled to assume that the peak is coming from a different isotopic distribution:
The volume of the −1*mass(neutron)/charge peak (see step 3b) must exceed a certain a certain intensity (the volume of the −1*mass(neutron)/charge peak must be greater than ⅔ of the expected previous isotope of calculated 3D-peak), that it can be assumed that the identified 3D-peak is a heavier isotope of another analyte.
The highest intensity of the one or the other peak must be in the range of the other one (the time ranges must overlap).
The intensity in the previous chromatogram at the time point of the summit of the 3D peak must be bigger than 15% of the peaks −1*mass(neutron)/charge summit.
If this intensity exceeds 70%, the peak is rated to come from a different isotope.
If not, it is checked if the highest intensity of the isotopic peak is close to the centre of the 3D peak (“inner-third” criterion is applied for the time dimension; for a detailed description of the inner third criterion see step 6).

### Step 4) Discard of Very Small Peaks

If step 3 identifies more than one peak, this step removes those peaks, whose intensity is smaller than 1% of the most intense peak found in the chromatogram.

### Step 5) Removal of Additional Isotopic Peaks

The 3D approach has high discriminatory power and segregates peaks easily. So it can happen that a part of a peak becomes a separate instance. If the segregation happens just for the m/z(analyte) chromatogram (makes 2 peaks out of 1) and not in the m/z(analyte)—mass(neutron)/charge chromatogram, the algorithm removes just the peak which is closer to the centre of the peak in the m/z of analyte—mass(neutron)/charge chromatogram, and the smaller one remains (see FIG. 4). The present step checks if between the encircled peak and the analyte (big peak in the chromatogram FIG. 4) a peak from a different isotopic distribution has been found (the time distance between the 2 peaks must not be more than 30 s otherwise it cannot be assumed that the peak exists due to an invalid peak separation; and the volume of the bigger peak must be 3 times the one of the smaller one). In that case, the smaller peak (the small one encircled by an ellipse) is removed.

Step 6) Merging of neighbouring peaks using stringent thresholds.

The 3D algorithm easily segregates the peaks if the steepness of the curve decreases abruptly. This step merges peaks that have for example two summits. In order to merge 2 peaks, the peaks have to fulfil one of the following 2 criteria:
The retention time regions of the peak overlap or touch and the m/z values assigned to the highest intensity of the peak do not differ more than a certain m/z range from one another (FT=2 mDa; Q-TOF=10 mDa; Q-TRAP=15 mDa); and/or
The probes are timely in the “inner-third” of the other peak and the ellipse m/z range of one peak contains the m/z value assigned to the highest intensity of the peak.
For the “inner third” the time range from the centre (summit) to the border of the peak is divided into thirds; the time point of interest fulfils the criterion if it is within the third that is next to the centre. However, if the peak is a small adjacent peak, the range to the border point (overlap) is normally smaller than the real time distance to the border. For this case the “inner-third” would be a quite narrow region, thus 2 thresholds are calculated that define the start of the “inner third”. In order to illustrate this methodology the following example shows the calculation of the lower threshold for the inner third, whereas the peak1 is timely before peak2:

lowerThreshold1=time(summit2)−(time(summit2)−startTime(peak2)/3

lowerThreshold2=time(summit2)−(stopTime(peak2)−startTime(peak2))/6

If the retention time of peak 1 is now bigger than lowerThreshold1 and/or lowerThreshold2, peak1 is timely in the inner third of the other peak.

If a merge is indicated again an ellipse is calculated. For the calculation of the ellipse the farthest points from the centre are taken. The following example should illustrate the procedure:

There are two peaks (1 and 2) which have to be merged, whereas peak 1 is in time and m/z direction before peak 2, and peak 2 has the higher intensity at the summit. Then we can assume that the centre of the new merged peak is where we found the highest intensity ->the summit of peak 2. Starting from this centre (summit of peak 2) we want to find border points (characterized by m/z and time). Thus our border points would be

| m/z | time | explanation |
|---|---|---|
| m/z(centre) | startTime | the start time of peak 1 is used, because it is |
| | (peak1) | timely before peak 2 |
| m/z(centre) | stopTime | the stop time of peak 2 is used because it is |
| | (peak2) | timely after peak 1 |
| startM/z | time(centre) | the lowest m/z of peak 1 is used, because |
| (peak1) | | peak 1 has a lower m/z border than peak 2. |
| stopM/z | time(centre) | the highest m/z of peak 2 is used, because |
| (peak2) | | peak 2 has a lower m/z border than peak 1 |

Step 7) Chromatogram Extraction and Peak Calculation for Additional Isotopes

Until this step, just the peaks for the +0 isotope have been calculated. In this step, the additional isotopes (+1, or possibly +2) are calculated. The chromatograms are extracted in the same manner like 1) and 2) and the peaks are calculated with the 3D algorithm step 3a. If the volumes of the isotopic distribution are outside the ranges defined by

$$\frac{idealCalculatedRatio}{7} < \frac{Area ( isotopeX )}{Area ( isotope0 )} < {2}^{*} idealCalculatedRatio ,$$

the peak is discarded. The terms of the equation are defined as follows:
idealCalculatedRatio: ratio that is calculated according to theoretical isotopic distribution as presented in example 3
Volume(isotope0): measured quantity for the +0 isotope
Volume(isotopeX): measured quantity for the +X isotope

### Step 8) Discard of Small Peaks

This step is similar to step 4. It is repeated here with higher threshold. The reason that it was not done before, is that the highest peak is probably the wrong one, and the correct one would have been removed. With 6) and 7) we overcame the problems of a too early removal of such a peak. In this step, volumes that are far away from the biggest peak (>30sec time distance between the peaks) have to surpass a higher cut-off value (currently 10%) than close ones (currently 1% for FT and 5% for Q-TOF and Q-TRAP).

Step 9) Calculation of Additional Isotopic Peaks that need not Fit the Isotopic Distribution

This calculation is similar to the calculation presented in step 7) with the exception that hits are not discarded to prevent loss of good hits. These peaks are calculated if present but do not serve as quality/exclusion criterion, because peaks of higher isotope numbers tend to have smaller intensities which cannot be differentiated from noise or do not match the theoretical isotopic distribution.

Step 10) Merging of neighbouring peaks using relaxed thresholds.

This step does nearly the same like step 6. However, there are less strict criteria applied for the merging. The reason for stricter criteria at step 6 is that by to rigorous mergings discriminatory power may get lost. However, after the peaks passed step 7-9, there is no reason against merging. Criteria for the merging:
The time distance between the peaks must not exceed 10 s.
There must not be a “deep valley” between the peaks. A “deep valley” is characterized by a decrease of an intensity value (from the chromatogram extracted in step 1), that lies between the two summits, to 80% of the less intense summit.

### EXAMPLE 5

### Application of Algorithm to Biological Data

The algorithm was successfully applied to the analysis of lipid droplets isolated from mouse hepatocytes, comparing three different dietary states: High fat diet, chow diet and fasted (FIG. 5). Three mice for each state were used in the study.

The data has been analyzed on the one hand with the standard ASAPRatio algorithm (Li et al, Anal. Chem 2003; 75: 6648-6657) as implemented in MASPECTRAS (Hater et al, BMC Bioinformatics 2007; 8:197) and on the other hand with the new algorithm presented here. In total, 9 samples have been analyzed comprising 727 peaks to quantify.

| | | in- | Not | expected | Additional |
|---|---|---|---|---|---|
| | correct | correct | identified | peaks | incorrect |
| MASPECTRAS | 587 | 140 | 0 | 727 | 81 |
| new algorithm | 678 | 4 | 45 | 727 | 2 |

The new algorithm significantly improved the amount of correctly identified peaks and reduced the number of incorrect identifications. The new algorithm rather tends to neglect questionable hits (thus some “not identified” hits) while the MASPECTRAS algorithm quantifies incorrect peaks. The main reason for missed identification was that the peak volumes were already so small that the +1 isotopic peak was not identifiable anymore. The MASPECTRAS algorithm does not take the isotopic distribution into account and thus quantified sometimes the correct peak, while the new algorithm discarded it (this mainly affected analytes with weak signals). However, most of the 45 hits, not identified by the new algorithm, have not been identified by the MASPECTRAS algorithm either. The MASPECTRAS algorithm mostly identified incorrect peaks instead, while the new algorithm discarded them. Furthermore, by using the new algorithm, 93.3% of the analysed peaks are identified correctly. In contrast, the MASPECTRAS algorithm identified 80.7%. Using the new algorithm, 0.9% of the identifications are incorrect (just 6 out of 684), while with the MASPECTRAS algorithm 27.4% of the identifications are incorrect. To summarize, the new algorithm is characterized by high positive predictive value, which is required for high-throughput analysis of data.

While the invention has been illustrated and described in detail in drawings and foregoing description, such illustration and description are to be considered illustrative or exemplary and not restrictive. It will be understood that changes and modifications may be made by those of ordinary skill within the scope and spirit of the following claims. In particular, the present invention covers further embodiments with any combination of features from different embodiments described above and below.

The invention also covers all further features shown in the Figures individually although they may not have been described in the afore or following description. Furthermore, in the claims the word “comprising” does not exclude other elements or steps, and the indefinite article “a” or “an” does not exclude a plurality. A single step may fulfil the functions of several features recited in the claims. The terms “essentially”, “about”, “approximately” and the like in connection with an attribute or a value particularly also define exactly the attribute or exactly the value, respectively. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A method for analysis of analytes in a sample comprising the steps of
providing a sample containing analytes.
measuring a first set of values of the analytes in the sample,
calculating a second set of values based on the measured first set of values, and
identifying the analytes by confining the measured first set of values of each analyte based on the second set of values in three or more dimensions; and optionally,
visualizing of each confined value of each identified analyte.

2. The method according to claim 1, wherein the identifying of the analytes comprises calculation of theoretical isotopic distribution of each analyte of interest from a chemical formula of each analyte.

3. The method according to claim 1, wherein the identifying of the analytes further comprises calculation of mass-to-charge-profile and chromatogram.

4. The method according to claim 1, wherein the identifying of the analytes comprises determination of four or more border values.

5. The method according to claim 1, wherein the three or more dimensions are selected from the group consisting of mass-to-charge-ratio, time and value intensity.

6. The method according to claim 1, wherein the identifying of the analytes further comprises filtering of values which do not fit to the theoretical isotopic distribution.

7. The method according to claim 1, wherein the analytes are selected from a group of mostly single-charged analytes consisting of nucleotides, amino acids, organic acids, sugars, free fatty acids, and lipids, or from a group of multiple-charged analytes consisting of peptides, and proteins.

8. The method according to claim 1, wherein the sample comprises a body fluid or tissue.

9. The method according to claim 8, wherein the body fluid is blood, plasma, serum, sweat, saliva, spinal fluid, feces, liquor, interstitial liquid, peritoneal liquid, lymph fluid, gall fluid, fluid from a glandular secretion, sputum, or urine.

10. The method according to claim 8, wherein the tissue is selected from a group consisting of tissue located beneath the skin, tissue around internal organs, tissue in bone marrow and tissue in breast.

11. A method for risk prediction of future life threatening events in disease which comprises analyzing analytes according to the method of claim 1 and evaluating results obtained thereby to provide risk predictive information of the disease.

12. The method according to claim 11, wherein disease is fat-related disease.

13. A method for monitoring progress or treatment of a disease, comprising the steps of:
(a) measuring values for the analytes by the method according to claim 1, wherein the measured values are predetermined to be indicative of the disease;
(b) repeating step (a) after a period of time during which subjects receive treatment for the disease, to obtain values representing post-treatment;
(c) comparing the values from step (b) representing post-treatment with the measured values in step (a) versus values representing subjects not suffering under the disease, and
(d) classifying said treatment as being effective if the values from step (b) representing post-treatment are closer to the values representing subjects not suffering under the disease than to the measured values from step (a).

14. The method according to claim 13, wherein the period of time is within a range of minutes, hours, days, months or years.

15. The method according to claim 13, wherein disease is fat-related disease.
